(19) United States
(12) Patent Application Publication
(10) Pub. No.: US 2024/0244635 A1
(43) Pub. Date: Jul. 18, 2024

(54) PDCCH CANDIDATE RESERVATION IN DCI COOPERATION

(71) Applicant: QUALCOMM Incorporated, San Diego, CA (US)

(72) Inventors: Fang YUAN, Beijing (CN); Shaozhen GUO, Beijing (CN); Aleksandar DAMNJANOVIC, Del Mar, CA (US); Tao LUO, San Diego, CA (US); Xiaoxia ZHANG, San Diego, CA (US)

(21) Appl. No.: 18/562,264

(22) PCT Filed: Jul. 14, 2021
(86) PCT No.: PCT/CN2021/106170

§ 371 Date: Nov. 17, 2023

(51) Int. Cl. H04W 72/232

(52) U.S. Cl. CPC H04W 72/232

(57) ABSTRACT

To facilitate UE cooperation for DCI reception, methods, apparatuses, and computer-readable storage medium are provided. An example method includes establishing a communication link with a second UE. The example method further includes reserving at least one of one or more first candidate resources or one or more second candidate resources of a plurality of candidate resources for a PDCCH reception. The example method further includes receiving, from a base station, an indication of the one or more first candidate resources for the PDCCH reception. The example method further includes receiving, from the second UE, at least one of one or more uncompressed bits corresponding to the one or more second candidate resources or one or more decoded bits corresponding to a reservation of the one or more second candidate resources.

### TECHNICAL FIELD

The present disclosure relates generally to communication systems, and more particularly, to wireless communication systems with physical downlink control channel (PDCCH).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first user equipment (UE) are provided. The apparatus may include a memory and at least one processor coupled to the memory. The memory and the at least one processor coupled to the memory may be configured to establish a communication link with a second UE. The memory and the at least one processor coupled to the memory may be further configured to reserve at least one of one or more first candidate resources or one or more second candidate resources of a plurality of candidate resources for a PDCCH reception. The memory and the at least one processor coupled to the memory may be further configured to receive, from a base station, an indication of the one or more first candidate resources for the PDCCH reception. The memory and the at least one processor coupled to the memory may be further configured to receive, from the second UE, at least one of one or more uncompressed bits corresponding to the one or more second candidate resources or one or more decoded bits corresponding to a reservation of the one or more second candidate resources.

In another aspect of the disclosure, a method, a computer-readable medium, and an apparatus at a second UE are provided. The apparatus may include a memory and at least one processor coupled to the memory. The memory and the at least one processor coupled to the memory may be configured to establish a communication link with a first UE. The memory and the at least one processor coupled to the memory may be further configured to receive, from a base station, an indication of one or more second candidate resources of a plurality of candidate resources for a PDCCH reception. The memory and the at least one processor coupled to the memory may be further configured to transmit, to the first UE, at least one of one or more uncompressed bits corresponding to the one or more second candidate resources or one or more decoded bits corresponding to a reservation of the one or more second candidate resources.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIGS. 4A and 4B are diagrams illustrating localized panels and distributed panels for a UE, in accordance with various aspects of the present disclosure.

FIG. 5 is a diagram illustrating a UE-to-UE link, in accordance with various aspects of the present disclosure.

FIG. 6 is a diagram illustrating PDCCH blind detection limits, in accordance with various aspects of the present disclosure.

FIGS. 7A and 7B are diagrams illustrating communication flows between a target UE, a cooperative UE, and a base station, in accordance with various aspects of the present disclosure.

FIGS. 8A and 8B illustrate example reservation (booking) of PDCCH candidate resources, in accordance with various aspects of the present disclosure.

FIGS. 9A and 9B are diagrams illustrating computing resources for decoding PDCCH candidate resources, in accordance with various aspects of the present disclosure.

FIG. 10 is a flowchart of a method of wireless communication, in accordance with various aspects of the present disclosure.

FIG. 11 is a flowchart of a method of wireless communication, in accordance with various aspects of the present disclosure.

FIG. 12 is a diagram illustrating an example of a hardware implementation for an example apparatus, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a diagram illustrating an example of a hardware implementation for an example apparatus, in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

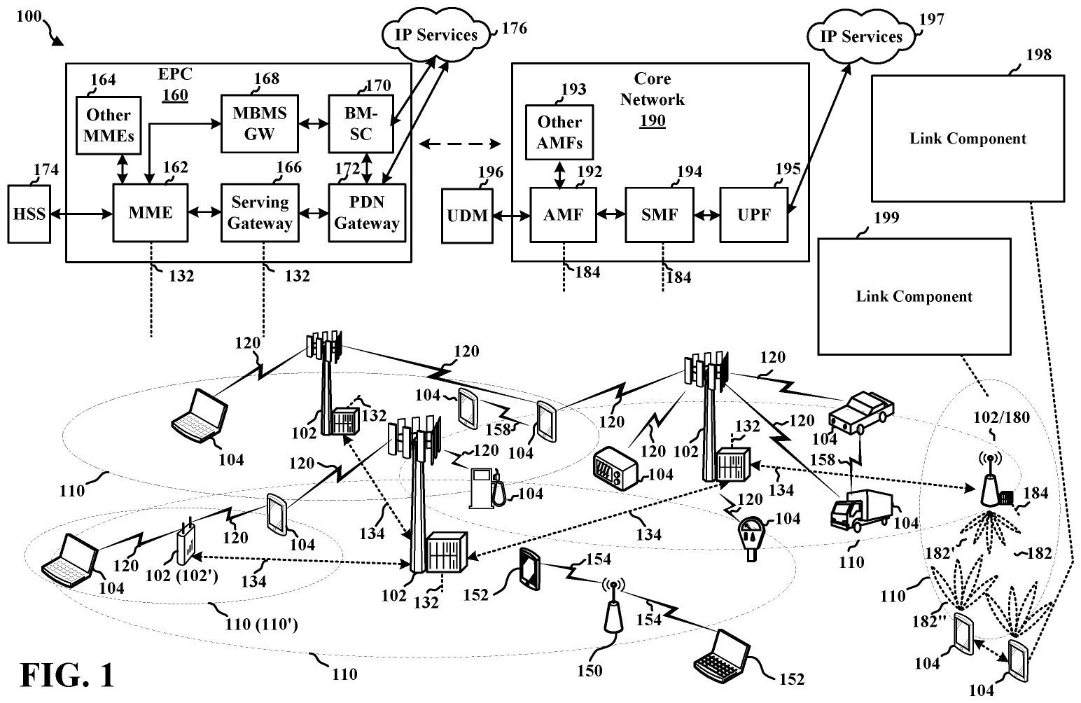

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a link component 198. In some aspects, the link component 198 may be configured to establish a communication link with a second UE. In some aspects, the link component 198 may be further configured to reserve at least one of one or more first candidate resources or one or more second candidate resources of a plurality of candidate resources for a PDCCH reception. In some aspects, the link component 198 may be further configured to receive, from a base station, an indication of the one or more first candidate resources for the PDCCH reception. In some aspects, the link component 198 may be further configured to receive, from the second UE, at least one of one or more uncompressed bits corresponding to the one or more second candidate resources or one or more decoded bits corresponding to a reservation of the one or more second candidate resources.

In certain aspects, another UE 104 may include a link component 199. In some aspects, the link component 199 may be configured to establish a communication link with a first UE. In some aspects, the link component 199 may be further configured to receive, from a base station, an indication of one or more second candidate resources of a plurality of candidate resources for a PDCCH reception. In some aspects, the link component 199 may be further configured to transmit, to the first UE, at least one of one or more uncompressed bits corresponding to the one or more second candidate resources or one or more decoded bits corresponding to a reservation of the one or more second candidate resources.

Although the following description may be focused on 5G NR, the concepts described herein may be applicable to other similar areas, such as LTE, LTE-A, CDMA, GSM, and other wireless technologies.

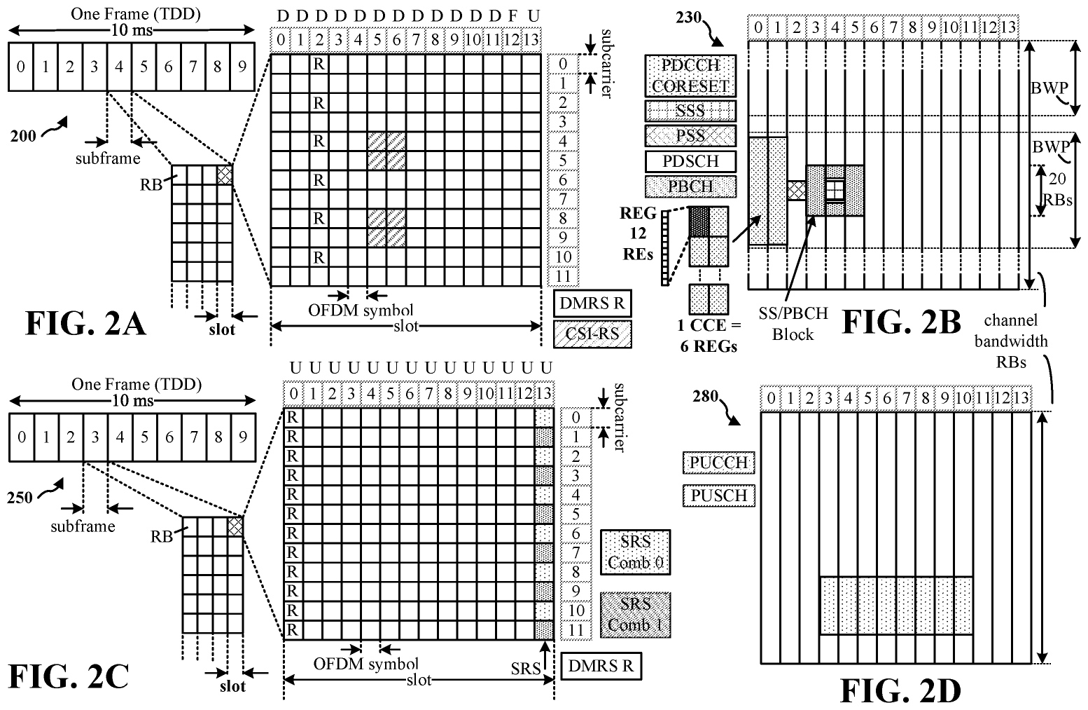

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2^{μ}*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

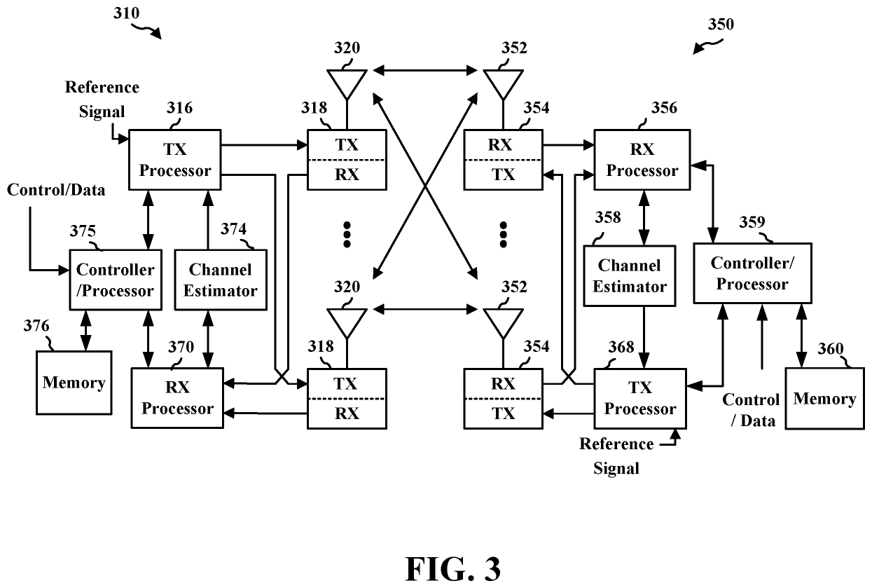

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with link component 198 or 199 of FIG. 1.

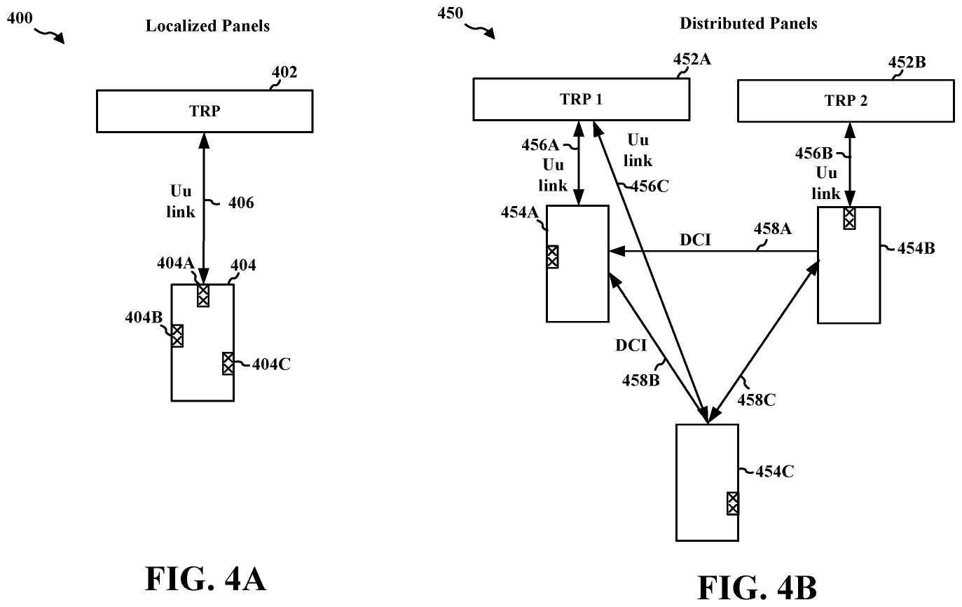

In some wireless communication systems, a UE may include multiple panels. For example, as illustrated in example 400 of FIG. 4A, a UE 404 may include multiple panels such as panel 404A, panel 404B, and panel 404C. The UE 404 may use one or more of the multiple panels (panel 404A, panel 404B, and panel 404C) to communicate with a transmission reception point (TRP) 402 of a base station via a Uu link 406. The UE 404 may be referred to as having multiple localized panels if the UE 404 includes the multiple panels (panel 404A, panel 404B, and panel 404C). In some aspects, each panel may include different RF modules that may each have a shared hardware or software controller. In some aspects, each panel may perform separate baseband processing. In some aspects, each panel may include a different antenna panel or a different set of antenna elements of a UE. For example, for a vehicle UE, each panel on the vehicle UE may include different antenna elements. In some aspects, panels on a UE may be physically separated. For example, as illustrated in example 400 of FIG. 4A, panel 404A, panel 404B, and panel 404C may be located on different part of the UE 404. By having multiple panels that may experience a particular channel differently (e.g., experience different channel qualities for a same channel) due to having different physical locations, a UE may be able to experience an improved communication quality.

For a UE equipped with one panel, the UE may be in communication with other UEs to enhance the communication quality (e.g., reliability). For example, as illustrated in example 450 of FIG. 4B, the UE 454A may be in communication with a first TRP 452A of a base station via a Uu link 456A. The UE 454A may be also in communication with one or more UEs, such as the UE 454B and the UE 454C. The UEs 454B and 454C may be in communication with the UE 454A via UE-to-UE link 458A and UE-to-UE link 458B. The UEs 454B and 454C may also be in communication with each other via UE-to-UE link 458C. As one non-limiting example, the UE-to-UE links may be cooperating links that include OFDM symbols or RE level in-phase and quadrature (IQ) samples as payload. In some aspects, the UE 454B and the UE 454C may be in communication with a TRP 452B via Uu link 456B and Uu link 456C. The TRP 452B and the TRP 452A may belong to a same base station.

As one example, the base station may transmit DCI to the UE 454A via the TRP 452A and the Uu link 456A. To enhance communication reliability, the base station may also transmit the DCI to the UE 454B and the UE 454C via the TRP 452B, the Uu link 456B, and the Uu link 456C. The UE 454B and the UE 454C may forward the DCI via the UE-to-UE link 458A and the UE-to-UE link 458B. Therefore, the UE 454A may receive the DCI via three different links—the Uu link 456A, the UE-to-UE link 458A, and the UE-to-UE link 458C. By diversifying the link which the DCI may be received, the UE 454A may experience a more reliable communication quality and a better communication quality. In some aspects, the UE 454A that receives the DCI may be referred to as a “target UE” and the UE 454B or 454C that forwards the DCI to the UE 454A may be referred to as a “cooperative UE.” Each of the UE 454A, UE 454B, and the UE 454C may be equipped with its own panel and the panel may be located on different physical locations relative to the UE, as illustrated in example 450 of FIG. 4B.

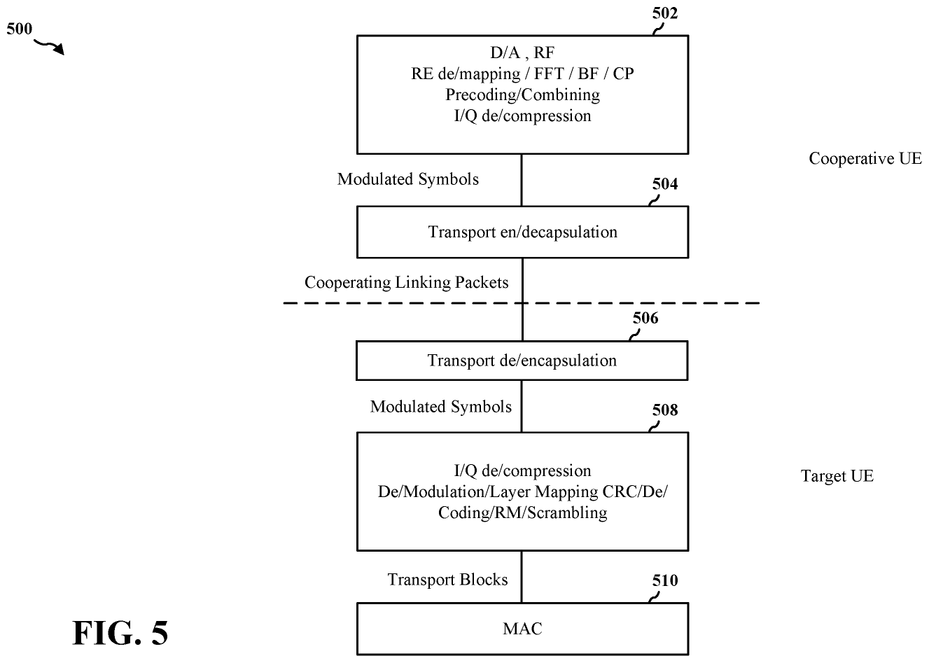

In one non-limiting example, the UE-to-UE links in FIG. 4B may be used for a low-level split for ultra-reliable low-latency communication (URLLC) or near-edge deployment. For example, as illustrated in example 500 of FIG. 5, at 502, a cooperative UE may perform digital/analog conversion (D/A), RF RE mapping/de-mapping, fast Fourier transform (FFT), block filter (BF), cyclic prefix (CP) precoding, combining I and Q samples, and decompression/compression. In one example, after 502, modulated symbols may be generated based on the signal received. In another example, 502 may be performed for modulated symbols generated based on 504. At 504, the cooperative UE may encapsulate modulated symbols for transport in the form of cooperating link (e.g., UE-to-UE link) packets (such as payload in the form of OFDM symbols over cooperating link or RE-level IQ samples) or may de-encapsulate received cooperating link packets to generate modulated symbols. The cooperating link packets may be transported to a target UE. The target UE may, at 506, de-encapsulate the cooperating link packets to extract the modulated symbols or may encapsulate modulated symbols to cooperating link packets. The target UE may, at 508, perform I/Q de-compression, de-modulation, layer mapping, a cyclic redundancy check (CRC), coding, rate matching (RM), or scrambling on transport blocks received from a medium access control (MAC) layer at 510 or may generate transport blocks for the MAC layer at 510. In some aspects, “uncompressed” may refer to a specific number of bits (such as 16-bits) for each IQ sample. In some aspects, modulation compression may be lossless. Other compressions (that may be lossy) may include one or more of: Block-Floating Point, μ-law, or the like.

To support the forwarding of DCI, a cooperative UE or a target UE may book (e.g., reserve) PDCCH candidates. For example, the target UE 454A may book (e.g., reserve) PDCCH candidates for the cooperative UE 454B or 454C. The cooperative UE 454B or 454C may decode the PDCCH transmitted via the PDCCH candidates and forward the decoded bits or directly forward IQ samples to the target UE 454A.

A UE may support a limited number of PDCCH candidates (which may be referred to as a PDCCH blind detection limit) because a UE may blindly decode PDCCH candidates and such blind decoding may consume a lot of computing resources for the UE. A UE may indicate its PDCCH blind detection limit to a base station. In some examples, a cooperative UE and a target UE may have different UE capabilities regarding PDCCH processing, such as the number of PDCCH blind detections, and book (reserve) a different number of PDCCH candidates. PDCCH candidates may be booked by a target TRP. For example, a UE may book PDCCH candidates from a TRP if a DCI for the UE is associated with the TRP. To differentiate between TRPs, an index parameter associated with TRPs such as CORESETPoolIndex may be used.

As one example for PDCCH blind detection limit, a maximum number M_{PDCCH}^{max,slot,μ} of monitored PDCCH candidates per slot for a DL BWP with SCS configuration μ∈{0, 1, 2, 3} for a single serving cell may be represented by Table 2 below:

TABLE 2

| | Maximum number of monitored PDCCH candidates |
|---|---|
| μ | per slot and per serving cell M_{PDCCH}^{max, slot, μ} |
| 0 | 44 |
| 1 | 36 |
| 2 | 22 |
| 3 | 20 |

In another example, a maximum number M_{PDCCH}^{max,(X,Y),μ} of monitored PDCCH candidates in a span for combination (X, Y) for a DL BWP with SCS configuration μ∈{0, 1} for a single serving cell may be represented by Table 3 below:

TABLE 3

| | Maximum number M_{PDCCH}^{max, (X, Y), μ} of monitored PDCCH | | |
|---|---|---|---|
| | candidates per span for combination (X, Y) and per serving cell | | |
| μ | (2, 2) | (4, 3) | (7, 3) |
| 0 | 14 | 28 | 44 |
| 1 | 12 | 24 | 36 |

A UE may split its PDCCH blind decoding capability into different portions for different TRPs of a base station. In some wireless communication systems, as one example, a PDCCH blind detection limit associated with the first TRP may be

$${M}_{PDCCH}^{total , {μ}_{1}} = ⌊ {M}_{PDCCH}^{max , {μ}_{1}} \cdot 4 \cdot \frac{2}{5} ⌋ .$$

A PDCCH blind detection limit associated with the second TRP may be

$${M}_{PDCCH}^{total , {μ}_{2}} = ⌊ {M}_{PDCCH}^{max , {μ}_{2}} \cdot 4 \cdot \frac{3}{5} ⌋ .$$

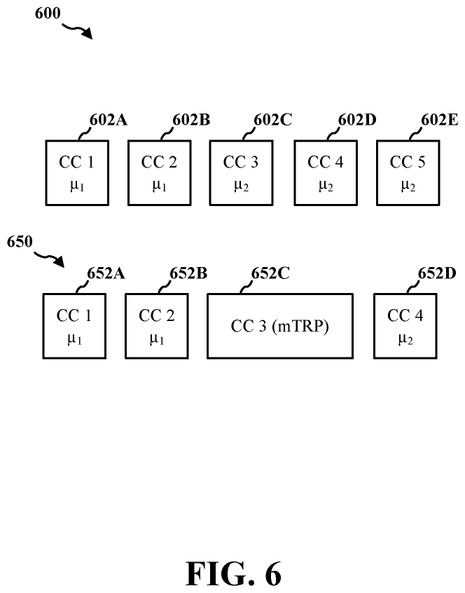

The PDCCH blind detection limit per cell scheduled may be min(M_{PDCCH}^{max,μ},M_{PDCCH}^{total,μ}). For example, as illustrated in example 600 of FIG. 6, μ₁ may denote SCS configuration associated with a first TRP of the base station and μ₂ may denote SCS configuration associated with a second TRP of the base station. Component carrier (CC) 1 602A and CC 2 602B may be associated with the first TRP and CC 3 602C, CC 4 602D, and CC 5 602E may be associated with the second TRP.

In another example, as illustrated in example 650 of FIG. 6, μ₁ may denote SCS configuration associated with a first TRP of the base station and μ₂ may denote SCS configuration associated with a second TRP of the base station, CC 1 652A and CC 2 652B may be associated with a first TRP and CC 4 652D may be associated with a second TRP. A CC may be associated with multiple TRPs, for example, CC3 652C may be associated with both the first TRP and the second TRP. In some wireless communication systems, as one example, a PDCCH blind detection limit associated with the first TRP may be

$${M}_{PDCCH}^{total , {μ}_{1}} = ⌊ {M}_{PDCCH}^{max , {μ}_{1}} \cdot 4 \cdot \frac{2}{5} ⌋ .$$

A PDCCH blind detection limit associated with the second TRP may be

$${M}_{PDCCH}^{total , {μ}_{2}} = ⌊ {M}_{PDCCH}^{max , {μ}_{2}} \cdot 4 \cdot \frac{3}{5} ⌋ .$$

A per scheduled cell limit for CC 3 652C may be min(2·M_{PDCCH}^{max,μ}^{₂},M_{PDCCH}^{total,μ}^{₂}) because CC3 652C is associated with both the first TRP and the second TRP. A per TRP limit for CC3 may be min(M_{PDCCH}^{max,μ}^{₂},M_{PDCCH}^{total,μ}^{₂}). Therefore, each multi-TRP CC may be counted as two single-TRP CCs and the UE may signal its blind detection limit accordingly to a base station.

Because the cooperative UE and target UE may have different UE capabilities on PDCCH processing, such as the number of PDCCH blind detections, and may book a different number of PDCCH candidates, booking PDCCH candidates by a target UE in UE cooperation may not be efficient in some cases. Some aspects provided herein may support a cooperative UE to book its PDCCH candidates for blind detections when the cooperative UE receives DCI for the target UE based on an information exchange between a UE-to-UE link.

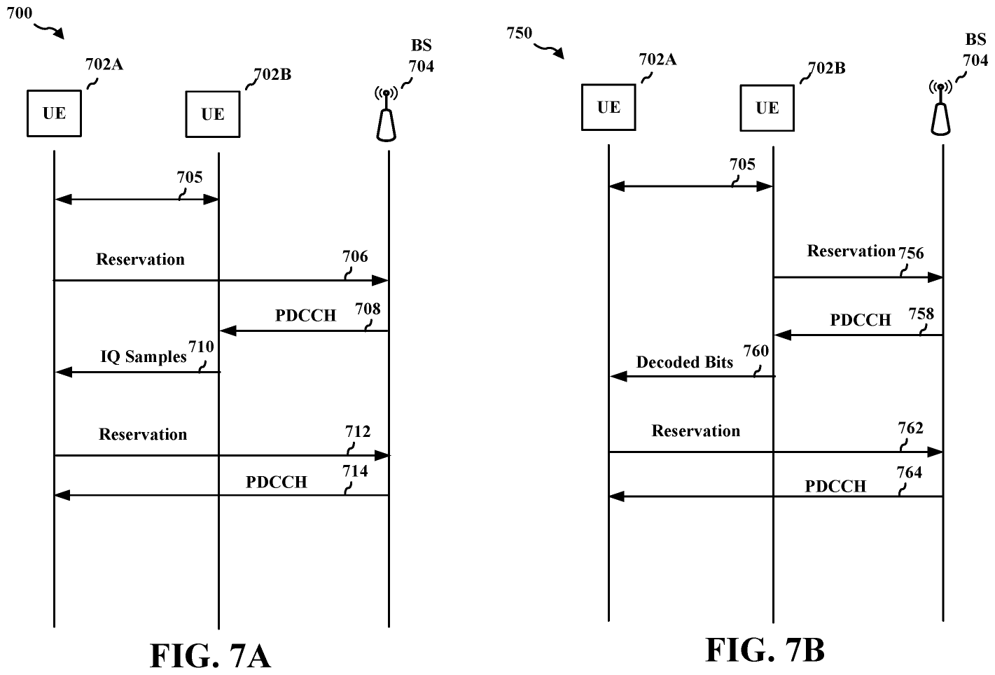

In some aspects, for a UE-to-UE link supporting IQ samples for a DCI related information exchange, a cooperative UE may not book its own PDCCH candidates to each PDCCH candidate reception for a target UE. In such aspects, the target UE may book its PDCCH candidates for each PDCCH candidates received by the cooperative UE. For example, in some aspects provided herein, the target UE 454A may perform the decoding on IQ samples forwarded by the cooperative UE 454B or 454C. The target UE 454A may book a PDCCH candidate and the cooperative UE 454B or 454C may receive the PDCCH in the PDCCH candidate then forward the IQ samples to the target UE 454A without decoding the PDCCH. The set of PDCCH candidates that are received by the cooperative UE 454B or 454C and forwarded to the target UE 454A may be pre-determined and statically allocated. In such scenarios, because the target UE 454A is performing the decoding, the blind detection limit of the target UE 454A may be applicable, the target UE 454A may perform the booking. As an example, FIG. 7A is a diagram illustrating communication flows between a target UE 702A, a cooperative UE 702B, and a base station 704. As illustrated in example 700 of FIG. 7A, the target UE 702A may establish connection 705 with the cooperative UE 702B. The target UE 702A may book PDCCH candidates (by transmitting a reservation 706 to the base station 704) and the PDCCH 708 may be transmitted via the booked PDCCH candidates to the cooperative UE 702B. Without decoding the PDCCH 708, the cooperative UE 702B may forward the IQ samples (generated based on the PDCCH 708) to the target UE 702A. The target UE 702A may still be capable of reserving a PDCCH (such as by transmitting reservation 712) and then receiving PDCCH 714 directly from the base station, similar to the Uu link 456A for the UE 454A illustrated in FIG. 4B.

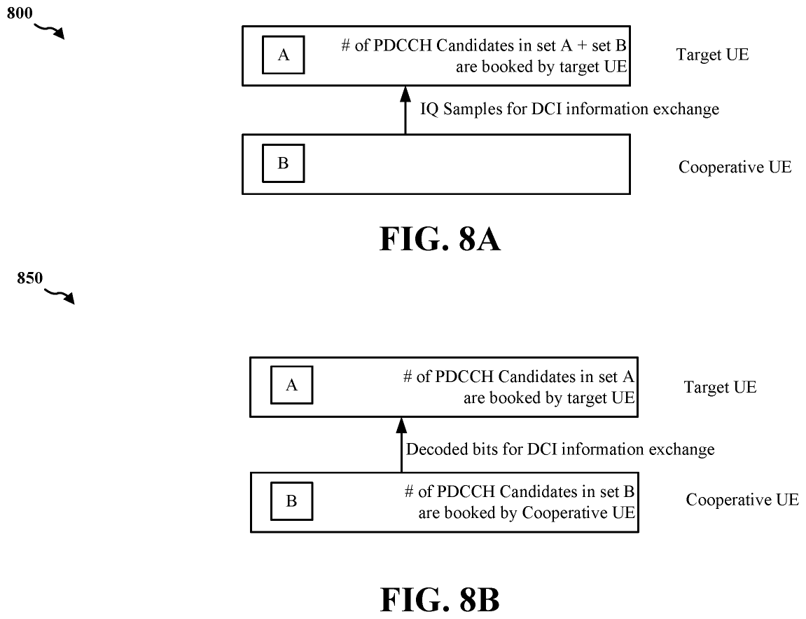

As illustrated in example 800 of FIG. 8A, in such aspects, a first set of PDCCH candidates (set A) that includes DCI for the target UE 702A directly transmitted to the target UE 702A may be booked by the target UE 702A. A second set of PDCCH candidates (set B) that includes DCI for the target UE 702A and may be transmitted to the cooperative UE 702B and then forwarded to the target UE 702A in the form of IQ samples may also be booked by the target UE 702A. In one example, if the target UE 702A is associated with a PDCCH blind detection limit of 4 and the cooperative UE is associated with a PDCCH blind detection limit of 5, the total number of PDCCH candidates in set A and set B may be less than or equal to 4.

For a UE-to-UE link supporting decoded bits for DCI related information exchange, a cooperative UE may book one of its own PDCCH candidates for each PDCCH candidate reception for a target UE. The target UE may not book its PDCCH candidates for each PDCCH candidates received by the cooperative UE. For example, in some aspects, the cooperative UE 454B or 454C may book a PDCCH candidate for the target UE 454A, then decode the PDCCH received for the target UE 454A and forward the decoded bits to the target UE 454A. The set of PDCCH candidates that are decoded by the cooperative UE 454B or 454C and forwarded to the target UE 454A may be pre-determined and statically allocated. In such scenarios, because the cooperative UE 454B (or 454C) is performing the decoding, the blind detection limit of the cooperative UE 454B (or 454C) may be applicable, the cooperative UE 454B (or 454C) may perform the booking. As an example, FIG. 7B is a diagram illustrating communication flows between a target UE 702A, a cooperative UE 702B, and a base station 704. As illustrated in example 750 of FIG. 7A, the target UE 702A may establish connection 705 with the cooperative UE 702B. The cooperative UE 702B may book PDCCH candidates (by transmitting a reservation 756 to the base station 704) and the PDCCH 758 may be received via the booked PDCCH candidates by the cooperative UE 702B. After decoding the PDCCH 758, the cooperative UE 702B may forward the decoded bits (generated based on the PDCCH 758) to the target UE 702A. In such aspects, the target UE 702A may still be capable of reserving a PDCCH (such as by transmitting reservation 762) and then receiving PDCCH 764 directly from the base station, similar to the Uu link 456A for the UE 454A illustrated in FIG. 4B.

As illustrated in example 850 of FIG. 8B, in such aspects, a first set of PDCCH candidates (set A) that includes DCI for the target UE 702A directly transmitted to the target UE 702A may be booked by the target UE 702A. A second set of PDCCH candidates (set B) that includes DCI for the target UE 702A and may be transmitted to the cooperative UE 702B and then forwarded to the target UE 702A in the form of decoded bits may be booked by the cooperative UE 702B. In one example, if the target UE 702A is associated with a PDCCH blind detection limit of 4 and the cooperative UE is associated with a PDCCH blind detection limit of 5, the total number of PDCCH candidates in set A may be less than or equal to 4 and the total number of PDCCH candidates in set B may be less than or equal to 5.

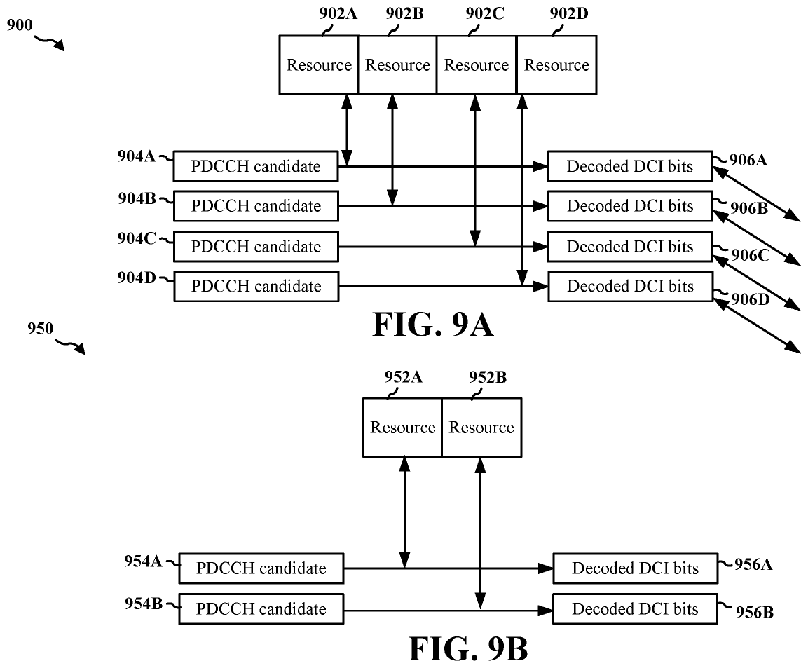

FIGS. 9A and 9B are diagrams illustrating computing resources for decoding PDCCH candidate resources. As illustrated in example 900 of FIG. 9A, a first set of computing resources 902A may be used for decoding PDCCH candidate 904A to generate decoded DCI bits 906A, a second set of computing resources 902B may be used for decoding PDCCH candidate 904B to generate decoded DCI bits 906B, a third set of computing resources 902C may be used for decoding PDCCH candidate 904C to generate decoded DCI bits 906C, and a fourth set of computing resources 902D may be used for decoding PDCCH candidate 904D to generate decoded DCI bits 906D. The PDCCH blind detection limit may be based on the amount of available computing resources at the UE. The PDCCH candidates 904A, 904B, 904C, and 904D may be decoded in parallel. For a cooperative UE, after generating the decoded DCI bits 906A, the decoded DCI bits 906B, the decoded DCI bits 906C, and the decoded DCI bits 906D using the computing resources 902A, 902B, 902C, and 902D of the cooperative UE, the cooperative UE may forward the decoded DCI bits 906A, the decoded DCI bits 906B, the decoded DCI bits 906C, and the decoded DCI bits 906D to the target UE. In some aspects, the cooperative UE may directly forward IQ samples to the target UE without decoding the PDCCH candidates.

As illustrated in example 950 of FIG. 9B, the target UE may also receive PDCCH candidates 954A and 954B and may use computing resources 952A and 952B to decode the PDCCH candidates to generate decoded DCI bits 956A and 956B.

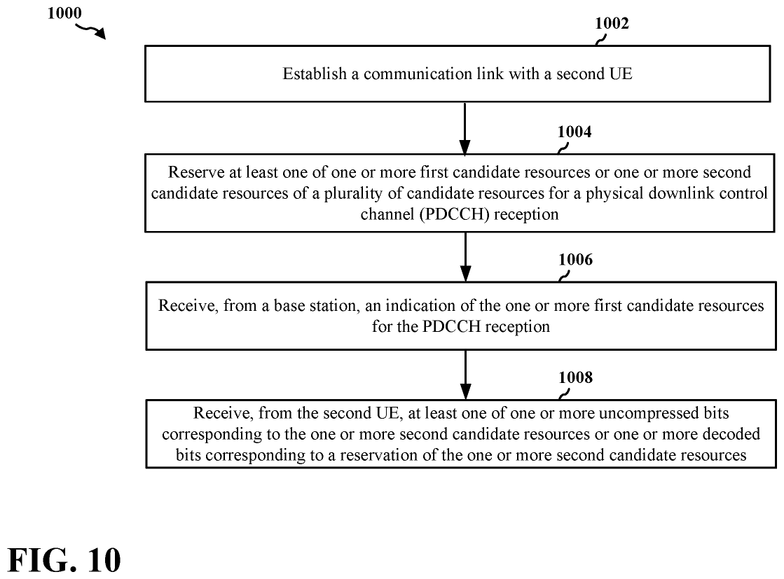

FIG. 10 is a flowchart 1000 of a method of wireless communication. The method may be performed by a first UE (e.g., the UE 104, the UE 702A, a target UE; the apparatus 1202).

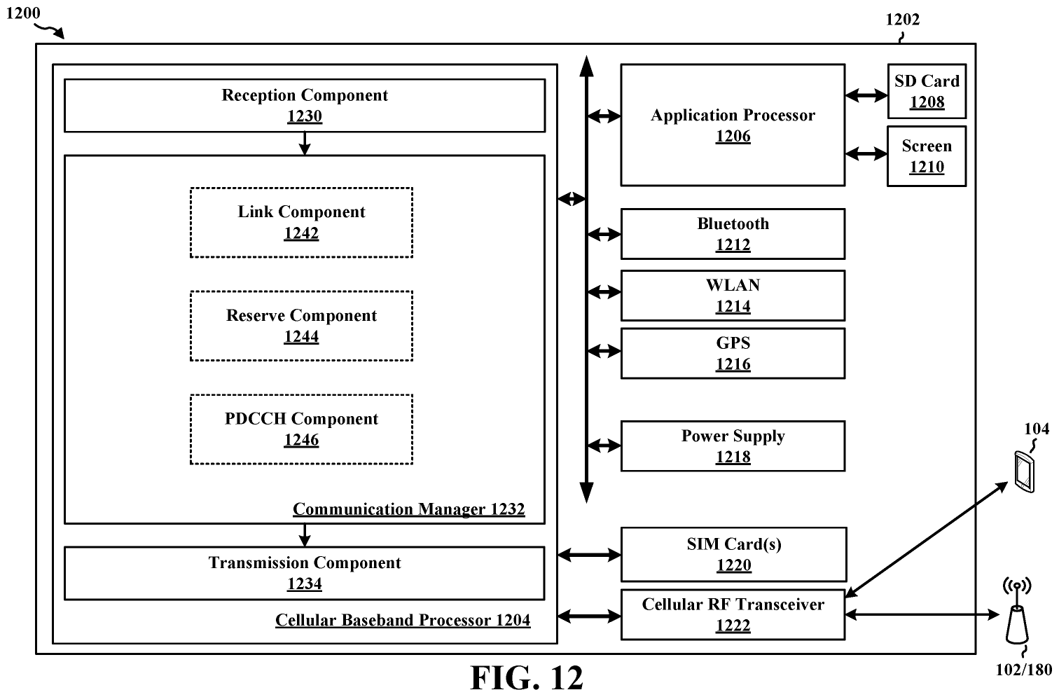

At 1002, the UE may establish a communication link with a second UE. For example, the UE 702A may establish a communication link with a second UE 702B to facilitate exchange of DCI information. In some aspects, 1002 may be performed by link component 1242 in FIG. 12.

At 1004, the UE may reserve at least one of one or more first candidate resources or one or more second candidate resources of a plurality of candidate resources for a PDCCH reception. For example, the UE 702A may reserve at least one of one or more first candidate resources (e.g., candidate resources for PDCCH 714 or 764) or one or more second candidate resources (e.g., candidate resources for PDCCH 708 or 758) of a plurality of candidate resources for a PDCCH reception. In some aspects, 1004 may be performed by reserve component 1244 in FIG. 12.

At 1006, the UE may receive, from a base station, an indication of the one or more first candidate resources for the PDCCH reception. For example, the UE 702A may receive, from a base station 704, an indication of the one or more first candidate resources for the PDCCH reception for PDCCH 714 or 764. In some aspects, 1006 may be performed by PDCCH component 1246 in FIG. 12.

At 1008, the UE may receive, from the second UE, at least one of one or more uncompressed bits corresponding to the one or more second candidate resources or one or more decoded bits corresponding to a reservation of the one or more second candidate resources. For example, the UE 702A may receive, from the second UE, at least one of one or more uncompressed bits (such as the IQ samples 710 or the decoded bits 760) corresponding to the one or more second candidate resources or one or more decoded bits corresponding to a reservation of the one or more second candidate resources. In some aspects, 1008 may be performed by link component 1242 in FIG. 12.

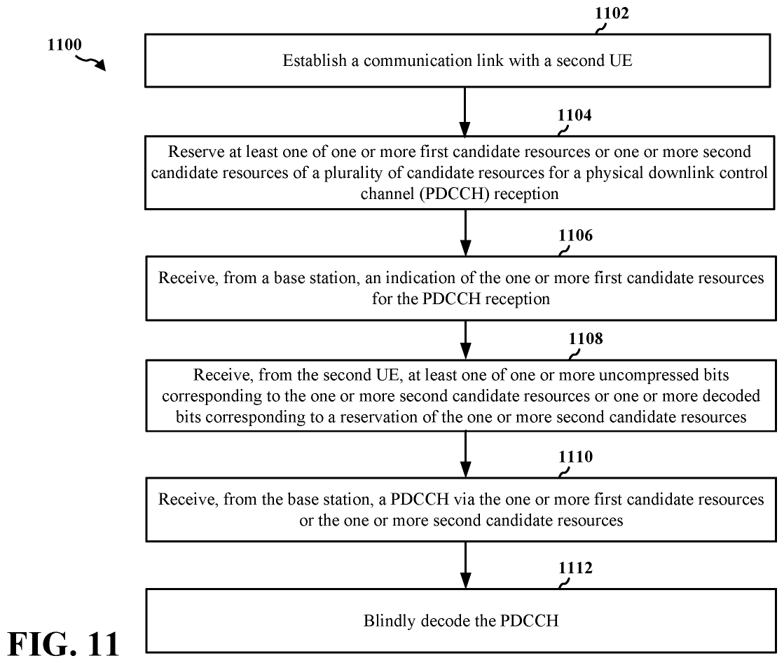

FIG. 11 is a flowchart 1100 of a method of wireless communication. The method may be performed by a first UE (e.g., the UE 104, the UE 702A, a target UE; the apparatus 1202).

At 1102, the UE may establish a communication link with a second UE. For example, the UE 702A may establish a communication link with a second UE 702B to facilitate exchange of DCI information. In some aspects, 1102 may be performed by link component 1242 in FIG. 12. In some aspects, the communication link is a UE-to-UE link. In some aspects, the first UE may be associated with a first PDCCH blind detection limit and the second UE may be associated with a second PDCCH blind detection limit. In some aspects, the one or more first candidate resources may include X number of candidate resources and the one or more second candidate resources includes Y number of candidate resources. In some aspects, X and Y may have different values. In some aspects, X and Y may have a same value.

At 1104, the UE may reserve at least one of one or more first candidate resources or one or more second candidate resources of a plurality of candidate resources for a PDCCH reception. For example, the UE 702A may reserve at least one of one or more first candidate resources (e.g., candidate resources for PDCCH 714 or 764) or one or more second candidate resources (e.g., candidate resources for PDCCH 708 or 758) of a plurality of candidate resources for a PDCCH reception. In some aspects, the reservation (such as the reservation 706) of the one or more second candidate resources may be performed by the first UE. In some aspects, the reservation (such as the reservation 756) of the one or more second candidate resources may not be performed by the first UE. In some aspects, 1104 may be performed by reserve component 1244 in FIG. 12.

At 1106, the UE may receive, from a base station, an indication of the one or more first candidate resources for the PDCCH reception. For example, the UE 702A may receive, from a base station 704, an indication of the one or more first candidate resources for the PDCCH reception for PDCCH 714 or 764. In some aspects, 1106 may be performed by PDCCH component 1246 in FIG. 12.

At 1108, the UE may receive, from the second UE, at least one of one or more uncompressed bits corresponding to the one or more second candidate resources or one or more decoded bits corresponding to a reservation of the one or more second candidate resources. For example, the UE 702A may receive, from the second UE 702B, at least one of one or more uncompressed bits (such as the IQ samples 710 or the decoded bits 760) corresponding to the one or more second candidate resources or one or more decoded bits corresponding to a reservation of the one or more second candidate resources. In some aspects, the one or more uncompressed bits may correspond to one or more IQ samples. In some aspects, at least one of the one or more uncompressed bits or the one or more decoded bits may correspond to a DCI related information exchange. In some aspects, 1108 may be performed by link component 1242 in FIG. 12. In some aspects, the one or more uncompressed bits may be associated with DCI and the DCI may be associated with a TRP of the first UE.

At 1110, the UE may receive, from the base station, a PDCCH via the one or more first candidate resources or the one or more second candidate resources. For example, the UE 702A may receive, from the base station 704, a PDCCH 714 or 764 via the one or more first candidate resources or the one or more second candidate resources. In some aspects, 1110 may be performed by PDCCH component 1246 in FIG. 12.

At 1112, the UE may blindly decode the PDCCH. For example, the UE 702A may blindly decode the PDCCH 714 or 764 received from the base station 704. In some aspects, 1112 may be performed by PDCCH component 1246 in FIG. 12.

FIG. 12 is a diagram 1200 illustrating an example of a hardware implementation for an apparatus 1202. The apparatus 1202 may be a UE, a component of a UE, or may implement UE functionality. In some aspects, the apparatus 1202 may include a cellular baseband processor 1204 (also referred to as a modem) coupled to a cellular RF transceiver 1222. In some aspects, the apparatus 1202 may further include one or more subscriber identity modules (SIM) cards 1220, an application processor 1206 coupled to a secure digital (SD) card 1208 and a screen 1210, a Bluetooth module 1212, a wireless local area network (WLAN) module 1214, a Global Positioning System (GPS) module 1216, or a power supply 1218. The cellular baseband processor 1204 communicates through the cellular RF transceiver 1222 with the UE 104 and/or BS 102/180. The cellular baseband processor 1204 may include a computer-readable medium/memory. The computer-readable medium/memory may be non-transitory. The cellular baseband processor 1204 is responsible for general processing, including the execution of software stored on the computer-readable medium/memory. The software, when executed by the cellular baseband processor 1204, causes the cellular baseband processor 1204 to perform the various functions described supra. The computer-readable medium/memory may also be used for storing data that is manipulated by the cellular baseband processor 1204 when executing software. The cellular baseband processor 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the cellular baseband processor 1204. The cellular baseband processor 1204 may be a component of the UE 350 and may include the memory 360 and/or at least one of the TX processor 368, the RX processor 356, and the controller/processor 359. In one configuration, the apparatus 1202 may be a modem chip and include just the baseband processor 1204, and in another configuration, the apparatus 1202 may be the entire UE (e.g., see 350 of FIG. 3) and include the additional modules of the apparatus 1202.

The communication manager 1232 may include a link component 1242 that is configured to establish a communication link with a second UE or receive, from the second UE, at least one of one or more uncompressed bits corresponding to the one or more second candidate resources or one or more decoded bits corresponding to a reservation of the one or more second candidate resources, e.g., as described in connection with 1002 and 1008 in FIGS. 10 and 1102 and 1108 in FIG. 11. The communication manager 1232 may further include a reserve component 1244 that may be configured to reserve at least one of one or more first candidate resources or one or more second candidate resources of a plurality of candidate resources for a PDCCH reception, e.g., as described in connection with 1004 in FIGS. 10 and 1104 in FIG. 11. The communication manager 1232 may further include a PDCCH component 1246 that may be configured to receive, from a base station, an indication of the one or more first candidate resources for the PDCCH reception, receive, from the base station, a PDCCH via the one or more first candidate resources or the one or more second candidate resources, or blindly decode the PDCCH e.g., as described in connection with 1006 in FIGS. 10 and 1106, 1110, and 1112 in FIG. 11.

The apparatus may include additional components that perform each of the blocks of the algorithm in the flowcharts of FIGS. 10 and 11. As such, each block in the flowcharts of FIGS. 10 and 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1202 may include a variety of components configured for various functions. In one configuration, the apparatus 1202, and in particular the cellular baseband processor 1204, may include means for establishing a communication link with a second UE. The cellular baseband processor 1204 may further include means for reserving at least one of one or more first candidate resources or one or more second candidate resources of a plurality of candidate resources for a PDCCH reception. The cellular baseband processor 1204 may further include means for receiving, from a base station, an indication of the one or more first candidate resources for the PDCCH reception. The cellular baseband processor 1204 may further include means for receiving, from the second UE, at least one of one or more uncompressed bits corresponding to the one or more second candidate resources or one or more decoded bits corresponding to a reservation of the one or more second candidate resources. The cellular baseband processor 1204 may further include means for receiving, from the base station, a PDCCH via the one or more first candidate resources or the one or more second candidate resources. The cellular baseband processor 1204 may further include means for blindly decoding the PDCCH. The means may be one or more of the components of the apparatus 1202 configured to perform the functions recited by the means. As described supra, the apparatus 1202 may include the TX Processor 368, the RX Processor 356, and the controller/processor 359. As such, in one configuration, the means may be the TX Processor 368, the RX Processor 356, and the controller/processor 359 configured to perform the functions recited by the means.

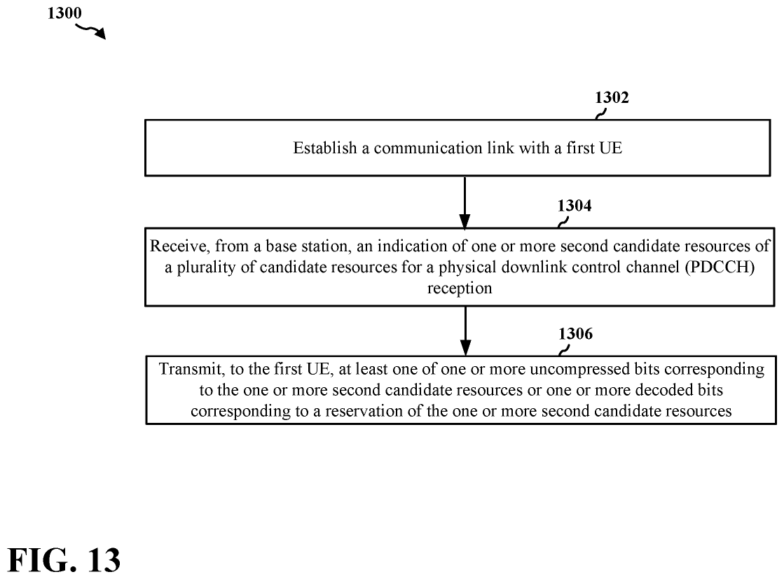

FIG. 13 is a flowchart 1300 of a method of wireless communication. The method may be performed by a first UE (e.g., the UE 104, the UE 702B, a cooperative UE; the apparatus 1502).

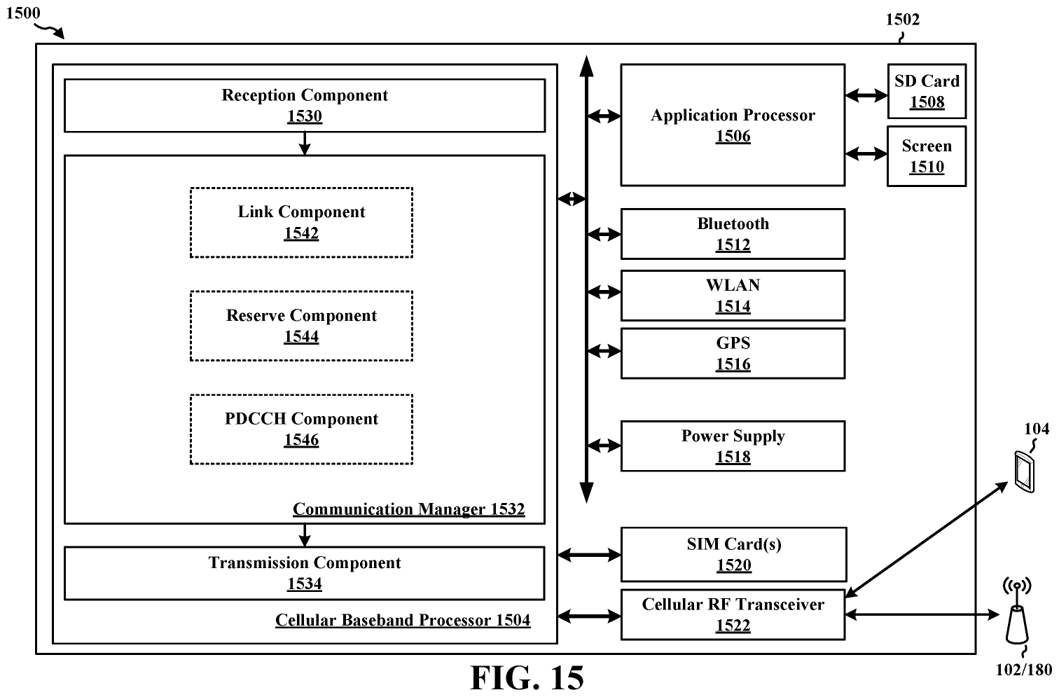

At 1302, the UE may establish a communication link with a first UE. For example, the UE 702B may establish a communication link with a first UE 702A to facilitate exchange of DCI information. In some aspects, 1302 may be performed by link component 1542 in FIG. 15.

At 1304, the UE may receive, from a base station, an indication of the one or more second candidate resources for the PDCCH reception. For example, the UE 702B may receive, from a base station 704, an indication of the one or more second candidate resources for the PDCCH reception for PDCCH 708 or 758. In some aspects, 1304 may be performed by PDCCH component 1546 in FIG. 15.

At 1306, the UE may transmit, to the first UE, at least one of one or more uncompressed bits corresponding to the one or more second candidate resources or one or more decoded bits corresponding to a reservation of the one or more second candidate resources. For example, the UE 702B may transmit, to the first UE 702A, at least one of one or more uncompressed bits (such as the IQ samples 710 or the decoded bits 760) corresponding to the one or more second candidate resources or one or more decoded bits corresponding to a reservation of the one or more second candidate resources. In some aspects, 1306 may be performed by link component 1542 in FIG. 15.

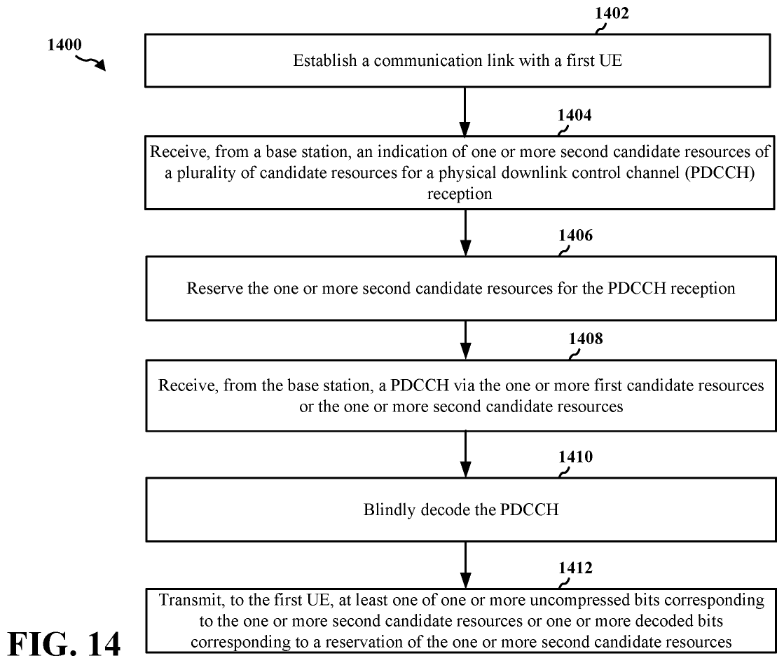

FIG. 14 is a flowchart 1400 of a method of wireless communication. The method may be performed by a first UE (e.g., the UE 104, the UE 702B, a cooperative UE; the apparatus 1502).

At 1402, the UE may establish a communication link with a first UE. For example, the UE 702B may establish a communication link with a first UE 702A to facilitate exchange of DCI information. In some aspects, 1402 may be performed by link component 1542 in FIG. 15. In some aspects, the communication link may be a UE-to-UE link. In some aspects, the first UE may be associated with a first PDCCH blind detection limit and the second UE may be associated with a second PDCCH blind detection limit. In some aspects, the one or more first candidate resources may include X number of candidate resources and the one or more second candidate resources includes Y number of candidate resources. In some aspects, X and Y may have different values. In some aspects, X and Y may have a same value.

At 1404, the UE may receive, from a base station, an indication of the one or more second candidate resources for the PDCCH reception. For example, the UE 702B may receive, from a base station 704, an indication of the one or more second candidate resources for the PDCCH reception for PDCCH 708 or 758. In some aspects, 1404 may be performed by PDCCH component 1546 in FIG. 15.

In some aspects, the reservation of the one or more second candidate resources may be performed by the first UE. In some aspects, the reservation of the one or more second candidate resources may not be performed by the first UE. In some aspects, at 1406, the UE may reserve the one or more second candidate resources for the PDCCH reception. For example, the UE 702B may reserve (e.g., in reservation 756) the one or more second candidate resources for the PDCCH reception (e.g., for the PDCCH 758). In some aspects, 1406 may be performed by reserve component 1544 in FIG. 15.

At 1408, the UE may receive, from the base station, a PDCCH via the one or more first candidate resources or the one or more second candidate resources. For example, the UE 702B may receive, from the base station 704, a PDCCH 708 or 758 via the one or more first candidate resources or the one or more second candidate resources. In some aspects, 1408 may be performed by PDCCH component 1546 in FIG. 15.

At 1410, the UE may blindly decode the PDCCH. For example, the UE 702B may blindly decode the PDCCH 708 or 758. In some aspects, 1410 may be performed by PDCCH component 1546 in FIG. 15.

At 1412, the UE may transmit, to the first UE, at least one of one or more uncompressed bits corresponding to the one or more second candidate resources or one or more decoded bits corresponding to a reservation of the one or more second candidate resources. For example, the UE 702B may transmit, to the first UE 702A, at least one of one or more uncompressed bits (such as the IQ samples 710 or the decoded bits 760) corresponding to the one or more second candidate resources or one or more decoded bits corresponding to a reservation of the one or more second candidate resources. In some aspects, 1412 may be performed by link component 1542 in FIG. 15. In some aspects, the one or more uncompressed bits may correspond to one or more IQ samples. In some aspects, at least one of the one or more uncompressed bits or the one or more decoded bits may correspond to a DCI related information exchange. In some aspects, the one or more uncompressed bits may be associated with DCI and the DCI may be associated with a TRP of the first UE.

FIG. 15 is a diagram 1500 illustrating an example of a hardware implementation for an apparatus 1502. The apparatus 1502 may be a UE, a component of a UE, or may implement UE functionality. In some aspects, the apparatus 1502 may include a cellular baseband processor 1504 (also referred to as a modem) coupled to a cellular RF transceiver 1522. In some aspects, the apparatus 1502 may further include one or more subscriber identity modules (SIM) cards 1520, an application processor 1506 coupled to a secure digital (SD) card 1508 and a screen 1510, a Bluetooth module 1512, a wireless local area network (WLAN) module 1514, a Global Positioning System (GPS) module 1516, or a power supply 1518. The cellular baseband processor 1504 communicates through the cellular RF transceiver 1522 with the UE 104 and/or BS 102/180. The cellular baseband processor 1504 may include a computer-readable medium/memory. The computer-readable medium/memory may be non-transitory. The cellular baseband processor 1504 is responsible for general processing, including the execution of software stored on the computer-readable medium/memory. The software, when executed by the cellular baseband processor 1504, causes the cellular baseband processor 1504 to perform the various functions described supra. The computer-readable medium/memory may also be used for storing data that is manipulated by the cellular baseband processor 1504 when executing software. The cellular baseband processor 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the cellular baseband processor 1504. The cellular baseband processor 1504 may be a component of the UE 350 and may include the memory 360 and/or at least one of the TX processor 368, the RX processor 356, and the controller/processor 359. In one configuration, the apparatus 1502 may be a modem chip and include just the baseband processor 1504, and in another configuration, the apparatus 1502 may be the entire UE (e.g., see 350 of FIG. 3) and include the additional modules of the apparatus 1502.

The communication manager 1532 may include a link component 1542 that is configured to establish a communication link with a first UE or transmit, to the first UE, at least one of one or more uncompressed bits corresponding to the one or more second candidate resources or one or more decoded bits corresponding to a reservation of the one or more second candidate resources, e.g., as described in connection with 1302 and 1306 in FIGS. 13 and 1402 and 1412 in FIG. 14. The communication manager 1532 may further include a reserve component 1544 that may be configured to reserve the one or more second candidate resources for the PDCCH reception, e.g., as described in connection with 1406 in FIG. 14. The communication manager 1532 may further include a PDCCH component 1546 that may be configured to receive, from a base station, an indication of one or more second candidate resources of a plurality of candidate resources for a PDCCH reception, receive, from the base station, a PDCCH via the one or more first candidate resources or the one or more second candidate resources, or blindly decode the PDCCH, e.g., as described in connection with 1304 in FIGS. 13 and 1404, 1408 and 1410 in FIG. 14.

The apparatus may include additional components that perform each of the blocks of the algorithm in the flowcharts of FIGS. 13 and 14. As such, each block in the flowcharts of FIGS. 13 and 14 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1502 may include a variety of components configured for various functions. In one configuration, the apparatus 1502, and in particular the cellular baseband processor 1504, may include means for establishing a communication link with a first UE. The cellular baseband processor 1504 may further include means for receiving, from a base station, an indication of one or more second candidate resources of a plurality of candidate resources for a PDCCH reception. The cellular baseband processor 1504 may further include means for reserving the one or more second candidate resources for the PDCCH reception. The cellular baseband processor 1504 may further include means for receiving, from the base station, a PDCCH via the one or more first candidate resources or the one or more second candidate resources. The cellular baseband processor 1504 may further include means for blindly decoding the PDCCH. The cellular baseband processor 1504 may further include means for transmitting, to the first UE, at least one of one or more uncompressed bits corresponding to the one or more second candidate resources or one or more decoded bits corresponding to a reservation of the one or more second candidate resources. The means may be one or more of the components of the apparatus 1502 configured to perform the functions recited by the means. As described supra, the apparatus 1502 may include the TX Processor 368, the RX Processor 356, and the controller/processor 359. As such, in one configuration, the means may be the TX Processor 368, the RX Processor 356, and the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a first UE, comprising: a memory; and at least one processor coupled to the memory and configured to: establish a communication link with a second UE; reserve at least one of one or more first candidate resources or one or more second candidate resources of a plurality of candidate resources for a PDCCH reception; receive, from a base station, an indication of the one or more first candidate resources for the PDCCH reception; and receive, from the second UE, at least one of one or more uncompressed bits corresponding to the one or more second candidate resources or one or more decoded bits corresponding to a reservation of the one or more second candidate resources.

Aspect 2 is the apparatus of aspect 1, wherein the communication link is a UE-to-UE link.

Aspect 3 is the apparatus of any of aspects 1-2, wherein the one or more uncompressed bits correspond to one or more IQ samples.

Aspect 4 is the apparatus of any of aspects 1-3, wherein the reservation of the one or more second candidate resources is performed by the first UE.

Aspect 5 is the apparatus of any of aspects 1-4, wherein at least one of the one or more uncompressed bits or the one or more decoded bits corresponds to a DCI related information exchange.

Aspect 6 is the apparatus of any of aspects 1-5, wherein the reservation of the one or more second candidate resources is not performed by the first UE.

Aspect 7 is the apparatus of any of aspects 1-6, wherein the at least one processor coupled to the memory is further configured to: receive, from the base station, a PDCCH via the one or more first candidate resources or the one or more second candidate resources.

Aspect 8 is the apparatus of any of aspects 1-7, wherein the at least one processor coupled to the memory is further configured to: blindly decode the PDCCH.

Aspect 9 is the apparatus of any of aspects 1-8, wherein the first UE is associated with a first PDCCH blind detection limit and the second UE is associated with a second PDCCH blind detection limit.

Aspect 10 is the apparatus of any of aspects 1-9, wherein the one or more first candidate resources include X number of candidate resources and the one or more second candidate resources include Y number of candidate resources.

Aspect 11 is the apparatus of any of aspects 1-10, wherein the one or more uncompressed bits are associated with DCI, and wherein the DCI is associated with a TRP of the first UE.

Aspect 12 is the apparatus of any of aspects 1-11, further comprising a transceiver coupled to the at least one processor.

Aspect 13 is an apparatus for wireless communication at a second UE, comprising: a memory; and at least one processor coupled to the memory and configured to: establish a communication link with a first UE; receive, from a base station, an indication of one or more second candidate resources of a plurality of candidate resources for a PDCCH reception; and transmit, to the first UE, at least one of one or more uncompressed bits corresponding to the one or more second candidate resources or one or more decoded bits corresponding to a reservation of the one or more second candidate resources.

Aspect 14 is the apparatus of aspect 13, wherein the communication link is a UE-to-UE link.

Aspect 15 is the apparatus of any of aspects 13-14, wherein the one or more uncompressed bits correspond to one or more IQ samples.

Aspect 16 is the apparatus of any of aspects 13-15, wherein the reservation of the one or more second candidate resources is not performed by the first UE.

Aspect 17 is the apparatus of any of aspects 13-16, wherein at least one of the one or more uncompressed bits or the one or more decoded bits corresponds to a DCI related information exchange.

Aspect 18 is the apparatus of any of aspects 13-17, wherein the at least one processor coupled to the memory is further configured to: reserve the one or more second candidate resources for the PDCCH reception.

Aspect 19 is the apparatus of any of aspects 13-18, wherein the at least one processor coupled to the memory is further configured to: receive, from the base station, a PDCCH via the one or more first candidate resources or the one or more second candidate resources.

Aspect 20 is the apparatus of any of aspects 13-19, wherein the at least one processor coupled to the memory is further configured to: blindly decode the PDCCH.

Aspect 21 is the apparatus of any of aspects 13-20, wherein the first UE is associated with a first PDCCH blind detection limit and the second UE is associated with a second PDCCH blind detection limit.

Aspect 22 is the apparatus of any of aspects 13-21, wherein the one or more first candidate resources include X number of candidate resources and the one or more second candidate resources include Y number of candidate resources.

Aspect 23 is the apparatus of any of aspects 13-22, wherein the one or more uncompressed bits are associated with DCI, and wherein the DCI is associated with a TRP of the first UE.

Aspect 24 is the apparatus of any of aspects 13-23, further comprising a transceiver coupled to the at least one processor.

Aspect 25 is a method of wireless communication for implementing any of aspects 1 to 12.

Aspect 26 is an apparatus for wireless communication including means for implementing any of aspects 1 to 12.

Aspect 27 is a computer-readable medium storing computer executable code, where the code when executed by a processor causes the processor to implement any of aspects 1 to 12.

Aspect 28 is a method of wireless communication for implementing any of aspects 13 to 24.

Aspect 29 is an apparatus for wireless communication including means for implementing any of aspects 13 to 24.

Aspect 30 is a computer-readable medium storing computer executable code, where the code when executed by a processor causes the processor to implement any of aspects 13 to 24.

What is claimed is:

1. An apparatus for wireless communication at a first user equipment (UE), comprising:
a memory; and
at least one processor coupled to the memory and configured to:
establish a communication link with a second UE;
reserve at least one of one or more first candidate resources or one or more second candidate resources of a plurality of candidate resources for a physical downlink control channel (PDCCH) reception;
receive, from a base station, an indication of the one or more first candidate resources for the PDCCH reception; and
receive, from the second UE, at least one of one or more uncompressed bits corresponding to the one or more second candidate resources or one or more decoded bits corresponding to a reservation of the one or more second candidate resources.

2. The apparatus of claim 1, wherein the communication link is a UE-to-UE link.

3. The apparatus of claim 1, wherein the one or more uncompressed bits correspond to one or more in-phase and quadrature (IQ) samples.

4. The apparatus of claim 3, wherein the reservation of the one or more second candidate resources is performed by the first UE.

5. The apparatus of claim 1, wherein at least one of the one or more uncompressed bits or the one or more decoded bits corresponds to a downlink control information (DCI) related information exchange.

6. The apparatus of claim 5, wherein the reservation of the one or more second candidate resources is not performed by the first UE.

7. The apparatus of claim 1, wherein the at least one processor coupled to the memory is further configured to:
receive, from the base station, a PDCCH via the one or more first candidate resources or the one or more second candidate resources.

8. The apparatus of claim 7, wherein the at least one processor coupled to the memory is further configured to:
blindly decode the PDCCH.

9. The apparatus of claim 1, wherein the first UE is associated with a first PDCCH blind detection limit and the second UE is associated with a second PDCCH blind detection limit.

10. The apparatus of claim 1, wherein the one or more first candidate resources include X number of candidate resources and the one or more second candidate resources include Y number of candidate resources.

11. The apparatus of claim 1, wherein the one or more uncompressed bits are associated with downlink control information (DCI), and wherein the DCI is associated with a transmission reception point (TRP) of the first UE.

12. The apparatus of claim 1, further comprising a transceiver coupled to the at least one processor.

13. An apparatus for wireless communication at a second user equipment (UE), comprising:
a memory; and
at least one processor coupled to the memory and configured to:
establish a communication link with a first UE;
receive, from a base station, an indication of one or more second candidate resources of a plurality of candidate resources for a physical downlink control channel (PDCCH) reception; and
transmit, to the first UE, at least one of one or more uncompressed bits corresponding to the one or more second candidate resources or one or more decoded bits corresponding to a reservation of the one or more second candidate resources.

14. The apparatus of claim 13, wherein the communication link is a UE-to-UE link.

15. The apparatus of claim 13, wherein the one or more uncompressed bits correspond to one or more in-phase and quadrature (IQ) samples.

16. The apparatus of claim 15, wherein the reservation of the one or more second candidate resources is not performed by the first UE.

17. The apparatus of claim 13, wherein at least one of the one or more uncompressed bits or the one or more decoded bits corresponds to a downlink control information (DCI) related information exchange.

18. The apparatus of claim 17, wherein the at least one processor coupled to the memory is further configured to:
reserve the one or more second candidate resources for the PDCCH reception.

19. The apparatus of claim 13, wherein the at least one processor coupled to the memory is further configured to:
receive, from the base station, a PDCCH via one or more first candidate resources or the one or more second candidate resources.

20. The apparatus of claim 19, wherein the at least one processor coupled to the memory is further configured to:
blindly decode the PDCCH.

21. The apparatus of claim 13, wherein the first UE is associated with a first PDCCH blind detection limit and the second UE is associated with a second PDCCH blind detection limit.

22. The apparatus of claim 13, wherein the one or more first candidate resources include X number of candidate resources and the one or more second candidate resources include Y number of candidate resources.

23. The apparatus of claim 13, wherein the one or more uncompressed bits are associated with downlink control information (DCI), and wherein the DCI is associated with a transmission reception point (TRP) of the first UE.

24. The apparatus of claim 13, further comprising a transceiver coupled to the at least one processor.

25. A method for wireless communication at a first user equipment (UE), comprising:
establishing a communication link with a second UE;
reserving at least one of one or more first candidate resources or one or more second candidate resources of a plurality of candidate resources for a physical downlink control channel (PDCCH) reception;
receiving, from a base station, an indication of the one or more first candidate resources for the PDCCH reception; and
receiving, from the second UE, at least one of one or more uncompressed bits corresponding to the one or more second candidate resources or one or more decoded bits corresponding to a reservation of the one or more second candidate resources.

26. The method of claim 25, wherein the one or more uncompressed bits correspond to one or more in-phase and quadrature (IQ) samples.

27. The method of claim 25, wherein at least one of the one or more uncompressed bits or the one or more decoded bits corresponds to a downlink control information (DCI) related information exchange.

28. A method for wireless communication at a second user equipment (UE), comprising:
establishing a communication link with a first UE;
receiving, from a base station, an indication of one or more second candidate resources of a plurality of candidate resources for a physical downlink control channel (PDCCH) reception; and
transmitting, to the first UE, at least one of one or more uncompressed bits corresponding to the one or more second candidate resources or one or more decoded bits corresponding to a reservation of the one or more second candidate resources.

29. The method of claim 28, wherein the one or more uncompressed bits correspond to one or more in-phase and quadrature (IQ) samples.

30. The method of claim 28, wherein at least one of the one or more uncompressed bits or the one or more decoded bits corresponds to a downlink control information (DCI) related information exchange.
